(19) United States
(12) Patent Application Publication
(10) Pub. No.: US 2009/0320771 A1
(43) Pub. Date: Dec. 31, 2009

(54) IONIC LIQUID MEDIUMS FOR HOLDING SOLID PHASE PROCESS GAS PRECURSORS

(75) Inventors: Robert Torres, JR., Parker, CO (US); Dane C. Scott, Doylestown, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Matheson Tri-Gas, Basking Ridge, NJ (US)

(21) Appl. No.: 12/480,961

(22) Filed: Jun. 9, 2009

Related U.S. Application Data
(60) Provisional application No. 61/060,382, filed on Jun. 10, 2008.

(51) Int. Cl. F22B 33/00; C09K 3/00

(52) U.S. Cl. 122/1 R; 252/372

(57) ABSTRACT

Ionic fluid mixtures are described that include an ionic liquid and a solid-phase material. The ionic liquid and the solid-phase material are selected to convert the solid-phase material into a gas phase material at a temperature that is lower than a conversion of the ionic liquid into a gas phase ionic material. In addition, methods of supplying a gaseous precursor to an application are described. These methods include providing a mixture of an ionic liquid and a solid-phase starting material, heating the mixture to a temperature that vaporizes at least a portion of the solid-phase starting material into the gaseous precursor, and transporting the gaseous precursor from the mixture to the application that utilizes the gaseous precursor.

### CROSS-REFERENCES TO RELATED APPLICATIONS

This application claims the benefit of U.S. Provisional Application No. 61/060,382 by Torres et al, filed Jun. 10, 2008, and titled “IONIC LIQUID MEDIUMS FOR HOLDING SOLID PHASE PROCESS GAS PRECURSORS.” This application is also related to U.S. patent application Ser. No. 11/101,191, by Wyse et al, filed Apr. 7, 2005, and titled “FLUID STORAGE AND PURIFICATION METHOD AND SYSTEM”. The entire contents of both applications is herein incorporated by reference for all purposes.

### BACKGROUND OF THE INVENTION

There are many industrial and electronic fabrication applications that require process gases. In semiconductor fabrication applications, for example, many specialty gases are used for depositing and doping material layers on semiconductor wafer substrates. Most of these specialty gases have to be supplied with very high purity, and many are highly toxic, flammable, or both, requiring extensive safety precautions for their transportation, storage and ultimate use in the fabrication application. The highly reactive nature of many of these materials also creates storage problems since a material can be prone to react with the storage equipment or even itself well before delivery to the end-use application.

Traditionally, most specialty gases were made and purified at a dedicated off-site facility and shipped in high-pressure cylinders by truck or rail to the site of the application. These processes has a number of drawbacks, including safety issues arising from the transportation and storage of flammable and/or toxic materials under high pressure, purity issues arising from contaminants in the gas manufacturing and storage equipment, and stability issues arising from transporting and storing highly reactive, unstable gases over long periods, among other issues. As end-use applications required an increasing purity and diversity of specialty gases, the need arose for alternate processes to supply these gases.

One alternate process is to make a solid precursor material that generated the specialty gas upon some activation event, such as heating, a chemical reaction, etc. A common technique is to place a powder of the precursor material on a heating plate and raise its temperature to a point where the powder starts releasing the specialty gas. In some instances, the powder melts and then evaporates to generate the gas, while in other instances the powder may sublimate from the solid directly into a gas. While these techniques are often successful at safely storing and stabilizing the specialty gas until it's ready for use, they also often suffer from consistency problems when the solid powder starts decomposing. The decomposition process typically results in the discrete particles of the powder melting and merging into a more uniform block of solid material having a much reduced surface area. As a result, the gas is released from the block at a decreasing delivery rate, which can cause unacceptable variations in the concentration of gas supplied to the application. Increasing the temperature of the block to try and correct for decreased delivery rate often just accelerates its degeneration into monolithic block with extremely reduced surface area.

The problems with inconsistent rates of supply of the specialty gas from a powder of precursor material has limited the usefulness this delivery mechanism for many applications. Furthermore, the inefficiencies resulting from converting only a fraction of the powdered precursor into gas and leaving a large chunk of potentially hazardous solid waste product often make these techniques economically and environmentally undesirable. Thus, there is a need for improved materials, methods and systems for supplying gases to application. This and other topics are addressed in the present application.

### BRIEF SUMMARY OF THE INVENTION

Mixtures are described of ionic liquids combined with solid-phase materials that are precursors to a gas used in an application (e.g., an electronics fabrication application). Because the mixture includes liquid and solid-phase components, it is a heterogeneous fluid that may be a suspension, a colloid, or a separated mixture wherein solid-phase particles have floated or settled from the liquid-phase ionic liquid. The solid-phase materials may dissolve to varying extents (e.g., negligibly to almost completely), and in some embodiments may completely dissolve in the ionic liquid.

The ionic liquid creates a physical and chemical spacing between the solid-phase particles and reduces the development of a bulk material over time. Moreover, the non-volatile, non-reactive nature of the ionic liquids allows the rapid and even transfer of heat and/or pressure from the ionic liquid to the solid-phase particles. This allows the mixture to generate a larger and more constant supply of gas from the solid-phase precursor materials at lower temperatures and pressure gradients than is possible with a dry particulate powder. Mechanical agitation of the mixture may also be performed to enhance or maintain the separation of solid-phase materials in the ionic liquid during the generation of gases.

Also described are methods and systems to supply gaseous materials from the solid-phase precursor materials mixed with the ionic liquids. These methods and systems use the above-described heterogeneous mixtures of ionic liquids and solid-phase precursor materials as a source to generate gaseous materials for an end-use application, such as a semiconductor fabrication process. These methods and systems may include process steps and equipment that cause the mixture to generate the gas. This may include steps and equipment to heat the mixture, bubble or sparge a carrier fluid through the mixture, apply a pressure gradient to the mixture, etc. The methods and systems may also include steps and equipment to recycle the ionic liquids in the mixtures and prepare and replenish the solid-phase material component of the mixtures.

Embodiments of the invention include ionic fluid mixtures that include an ionic liquid and a solid-phase material. The ionic liquid and the solid-phase material are selected to convert the solid-phase material into a gas phase material at a temperature that is lower than a conversion of the ionic liquid into a gas phase ionic material.

Embodiments of the invention also include systems to deliver a gaseous precursor from a solid-phase starting material. The systems may include a storage unit to hold a mixture comprising an ionic liquid and the solid-phase starting material. They may also include a heating unit thermally coupled to the storage unit to increase a temperature of the mixture in the storage unit. In addition, they may include a gas delivery unit fluidly coupled to the storage unit and adapted to transport the gaseous precursor that is formed by heating the solid phase starting material in the mixture. The gas delivery unit may transport the gaseous precursor to an application that is coupled to the system.

Embodiments of the invention further include methods of supplying a gaseous precursor to an application. These methods include the steps of providing a mixture of an ionic liquid and a solid-phase starting material, and heating the mixture to a temperature that vaporizes at least a portion of the solid-phase starting material into the gaseous precursor. The methods may further include transporting the gaseous precursor from the mixture to the application that utilizes the gaseous precursor.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a flowchart showing selected steps in a method of supplying a precursor gas for an application according to embodiments of the invention; and

FIG. 2 shows a simplified schematic of a precursor delivery system according to embodiments of the invention.

### DETAILED DESCRIPTION OF THE INVENTION

Mixtures of ionic liquids with solid-phase materials are described that can act as a storage medium for specialty gases used in various applications, including semiconductor fabrication applications. The mixtures permit the transportation, storage and delivery of the gases at much lower pressure than the same gas stored in a high-pressure gas cylinder. They also reduce unwanted reactions and contamination of the gases prior to use. Moreover, unlike dry-powder solid-phase precursors, the present mixtures do not decompose into a single block of material with reduced surface area and gas generating capacity.

Mixtures of Ionic Liquids with Solid-Phase Materials

The mixtures described may include an ionic liquid and a solid-phase precursor material that form a suspension, colloid, or separated mixture depending on the particle size of the solid-phase precursor and the fluid properties of the ionic liquid, among other factors. The mixtures may also have a concentration of the solid-phase material dissolved in the ionic liquid, and a concentration of one or more gases, including the gas that is ultimately released by the mixture and delivered to the application. In some embodiments, the mixture may also contain one or more intermediate compounds formed from the solid-phase precursor that are further converted into the application gas. In additional embodiments, the solid-phase precursor material may completely dissolve in the ionic-liquid to convert the mixture into a single-phase liquid solution. Additional details of two components used to make the mixtures (liquid ionic component and the solid-phase material) are provided below.

### The Ionic Liquid Component:

Ionic liquids are a class of materials commonly characterized by physical properties like relatively low vapor pressure, high thermal stability, and low viscosity. Generally, ionic liquids have a bulky, asymmetric cation and an inorganic anion. The bulky, asymmetric shape of the cation prevents tight packing, which decreases the melting point. The wide variety of cations and anions available for ionic liquids provide a wide range of solubility and suspension characteristics for organic and inorganic solid-phase precursor materials. Ionic liquids may be selected to provide the mixture with good suspension and dissolution characteristics, high thermal stability, non-flammability, low vapor pressure, low viscosity, and/or easier recyclability, among other qualities.

The ionic liquid in the mixture may be selected to for particular solubility characteristics at the activation temperature where the mixture generates gas. For example, the ionic liquid may be selected to have a relatively low solubility for the solid-phase precursor at an ambient storage temperature (e.g., 23-25° C.), but a much increased solubility for the precursor and/or its thermal decomposition products at the elevated activation temperature (e.g., about 150° C., 200° C., 250° C., 300° C., 350° C., 400° C., etc.). The temperature dependence of the solid-phase material's solubility may provide the ability to control the rate of gas release with changes to the temperature of the mixture. Moreover, differences in the solubility of the solid-phase precursor and residual impurities may provide a way to purify the released gas while leaving a disproportionate amount of the impurities in the mixture. In this sense, the ionic liquid may function as both a storage and purification medium for the released gases.

The solubility of a fluid intermediate in an ionic liquid may vary with properties in addition to temperature and pressure. For example, fluid solubility may also depend on the anion and cation of the ionic liquid. While not intending to be bound by any particular theory, current understanding suggests that the choice of anion in the ionic liquid may have a significant effect on fluid solubility: When there is more interaction between the anion and the fluid, fluid solubility may increase. Fluid solubility may also be influenced by the choice of cation, and the specific combinations of anions and cations used in the ionic liquid.

The purity of an ionic liquid may also effect the solubility of a fluid intermediate dissolved in the ionic liquid. Ionic liquids with reduced levels of moisture impurities (i.e., substantially anhydrous ionic liquids) may increase the solubility of a fluid in the ionic liquid. The increased solubility may be particularly pronounced for dissolved fluids that are hydrophobic, since they will have fewer repulsive interactions with water in the ionic liquid. Water and other impurities can be removed from the ionic liquid using conventional purification techniques, such as drying or baking the ionic liquid.

The ionic liquids may also stabilize the solid-phase precursor materials, the gases released from the precursors, intermediates between the solid-phase precursor and the gases, or combinations of these compounds. The stabilization effect may permit longer storage periods for the mixture, and may also decrease impurities in the supplied gas that are caused by the instability and reactivity of the precursors, intermediates, or released gases.

While not wishing to be bound to a specific theory, it is believed that the environment the precursors experience when mixed or dissolved in the ionic fluid increase the stability of those precursors. For gases and fluid intermediates dissolved in the ionic liquid, intermolecular forces may have a stabilizing effect, such as hydrogen bonding, dielectric constant, dipole moment (polarizability), high pi interaction, length of carbon chain, number of carbon double bonds, the purity of the ionic liquid, chirality, and steric hindrance. Ionic liquids are chosen that stabilize the solid-phase precursors and/or dissolve the fluids without irreversibly altering the chemical composition of these solids and fluids. In many instances, the fluids are dissolved in the ionic liquid without breaking intramolecular bonds which could irreversibly alter the chemical or physical properties of the fluid. The cations and anions of the ionic liquid may also surround individual fluid molecules making it more difficult for the molecules to react with each other and form unwanted impurities (including polymerized forms of the stored fluid).

The ionic liquids may be selected to have a substantially lower vapor pressure than the solid-phase precursor, intermediates, or released gases from the mixture. The reduced vapor pressure of the ionic liquid reduces the amount of evaporated ionic liquid that contaminates the released gas. Ionic liquids may be selected that have vapor pressures substantially lower than conventional polar-aqueous or non-polar organic solutions. For example, ionic liquids may be selected that have a vapor pressure of about 10⁻⁴ Torr or less, about 10⁻⁵ Torr or less, about 10⁻⁶ Torr or less, etc., at 25° C.

A variety of ionic liquids can be used in the mixture, and may consist of a single ionic liquid or a combination of two or more ionic liquids supplied in various ratios. The ionic liquids may generally include mono-substituted imidazolium salts, di-substituted imidazolium salts, tri-substituted imidazolium salts, pyridinium salts, pyrrolidinium salts, phosphonium salts, ammonium salts, tetralkylammonium salts, guanidinium salts, and isouronium salts.

In additional examples, the ionic liquids may include a cation component selected from mono-substituted imidazoliums, di-substituted imidazoliums, tri-substituted imidazoliums, pyridiniums, pyrrolidiniums, phosphoniums, ammoniums, tetralkylammoniums, guanidiniums, and uroniums; and an anion component selected from acetate, cyanates, decanoates, halogenides, sulfates, sulfonates, amides, imides, methanes, borates, phosphates, antimonates, tetrachoroaluminate, thiocyanate, tosylate, carboxylate, cobalt-tetracarbonyl, trifluoroacetate and tris(trifluoromethylsulfonyl)methide. The halogenide anions may include chloride, bromide, and iodide, among others. The sulfates and sulfonate anions may include methyl sulfate, ethyl sulfate, butyl sulfate, hexyl sulfate, octyl sulfate, hydrogen sulfate, methane sulfonate, dodecylbenzene sulfonate, dimethyleneglycolmonomethylether sulfate, trifluoromethane sulfonate, among others. The amides, imides, and methane anions may include dicyanamide, bis(pentafluoroethylsulfonyl)imide, bis(trifluoromethylsulfonyl)imide, bis(trifluoromethyl)imide, among others. The borate anions may include tetrafluoroborate, tetracyanoborate, bis[oxalato(2-)]borate, bis[1,2-benzenediolato(2-)—O,O′]borate, bis[salicylato(2-)]borate, among others. The phosphate and phosphinate anions may include hexafluorophosphate, diethylphosphate, bis(pentafluoroethyl)phosphinate, tris(pentafluoroethyl)trifluorophosphate, tris(nonafluorobutyl)trifluorophosphate, among others. Anitinonate anions may include hexafluoroantimonate, among others. Additional anions may include tetrachoroaluminate, acetate, thiocyanate, tosylate, carboxylate, cobalt-tetracarbonyl, trifluoroacetate and tris(trifluoromethylsulfonyl)methide, among others.

Some ionic liquids may be categorized by their acidity and chemical reactivity into standard, acidic, acidic water reactive, and basic categories. Standard ionic liquids may include but are not limited to 1-ethyl-3-methylimidazolium chloride, 1-ethyl-3-methylimidazolium methanesulfonate, 1-butyl-3-methylimidazolium chloride, 1-butyl-3-methylimidazolium methanesulfonate, methyl-tri-n-butylammonium methylsulfate, 1-ethyl-2,3-dimethylimidazolium ethylsulfate, 1,2,3-trimethylimidazolium methylsulfate, among others. Acidic ionic liquids may include methylimidazolium chloride, methylimidazolium hydrogensulfate, 1-ethyl-3-methylimidazolium hydrogensulfate, 1-butyl-3-methylimidazolium hydrogensulfate, among others. Acidic water reactive liquids may include 1-ethyl-3-methylimidazolium tetrachloroaluminate and 1-butyl-3-methylimidazolium tetrachloroaluminate, among others. Basic ionic liquids may include 1-ethyl-3-methylimidazolium acetate and 1-butyl-3-methylimidazolium acetate, among others.

Some ionic liquids may be categorized by the types of functional groups present on the cation. These categories may include mono-substituted imidazoliums, di-substituted imidazoliums, tri-substituted imidazoliums, pyridiniums, pyrrolidiniums, phosphoniums, ammoniums, tetralkylammoniums, guanidiniums, and uroniums, among others.

Mono-substituted imidazolium ionic liquids may include 1-methylimidazolium tosylate, 1-methylimidazolium tetrafluoroborate, 1-methylimidazolium hexafluorophosphate, 1-methylimidazolium trifluoromethanesulfonate, 1-butylimidazolium tosylate, 1-butylimidazolium tetrafluoroborate, 1-methylimidazolium hexafluorophosphate, and 1-methylimidazolium trifluoromethanesulfonate, among others. Di-substituted imidazolium ionic liquids may include 1,3-dimethylimidiazolium methylsulfate, 1,3-dimethylimidiazolium trifluoromethanesulfonate, 1,3-dimethylimidiazolium bis(pentafluoroethyl)phosphinate, 1-ethyl-3-methylimidiazolium thiocyanate, 1-ethyl-3-methylimidiazolium dicyanamide, 1-ethyl-3-methylimidiazolium cobalt-tetracarbonyl, 1-propyl-3-methylimidazolium chloride, 1-butyl-3-methylimidazolium hexafluoroantimonate, 1-octadecyl-3-methylimidazolium bis(trifluoromethylsulfonyl)imide, 1-benzyl-3-methylimidazolium bromide, 1-phenylpropyl-3-methylimidazolium chloride, among others. Tri-substituted imidazolium ionic liquids may include 1-ethyl-2,3-dimethylimidazolium chloride, 1-butyl-2,3-dimethylimidazolium octylsulfate, 1-propyl-2,3-dimethylimidazolium chloride, 1-hexyl-2,3-dimethylimidazolium tetrafluoroborate, 1-hexadecyl-2,3-dimethylimidazolium iodide, among others.

Pyridinium ionic liquids may include n-ethylpyridinium chloride, n-butylpyridinium bromide, n-hexylpyridinium n-octylpyridinium chloride, 3-methyl-n-butylpyridinium methylsulfate, 3-ethyl-n-butylpyridinium hexafluorophosphate, 4-methyl-n-butylpyridinium bromide, 3,4-dimethyl-n-butylpyridinium chloride, 3,5-dimethyl-n-butylpyridinium chloride, among others. Pyrrolidinium ionic liquids may include 1,1-dimethylpyrrolidinium tris(pentafluoroethyl)trifluorophosphate, 1-ethyl-1-methylpyrrolidinium dicyanamide, 1,1-dipropylpyrrolidinium bis(trifluoromethylsulfonyl)imide, 1-butyl-1-methylpyrrolidinium bromide, 1-butyl-1-ethylpyrrolidinium bromide, 1-octyl-1-methylpyrrolidinium dicyanamide, among others.

Phosphonium ionic liquids may include tetraoctylphosphonium bromide, tetrabutylphosphonium bis[oxalato(2-)]-borate, trihexyl(tetradecyl)phosphonium dicyanamide, benzyltriphenylphosphonium bis(trifluoromethyl)imide, tri-iso-butyl(methyl)phosphonium tosylate, ethyl(tributyl)phosphonium diethylphosphate, tributyl(hexadecyl)phosphonium chloride, among others. Ammonium ionic liquids may include tetramethylammonium bis(trifluoromethylsulfonyl)imide, tetraethylammonium bis-[salicylato-(2-)]-borate, tetrabutylammonium tetracyanoborate, methyltrioctylammonium trifluoroacetate, among others.

Guanidinium ionic liquids may include N,N,N′,N′,N″-pentamethyl-N″-isopropylguanidinium tris(pentafluoroethyl)trifluorophosphate, N,N,N′,N′,N″-pentamethyl-N″-isopropylguanidinium tris(pentafluoroethyl)trifluoromethanesulfonate, hexamethylguanidinium tris(pentafluoroethyl)trifluorophosphate, hexamethylguanidinium trifluoromethanesulfonate, among others. Uronium ionic liquids may include S-methyl-N,N,N′,N′-tetramethylisouronium trifluoromethanesulfonate, O-methyl-N,N,N′,N′-tetramethylisouronium tris(pentafluoroethyl)trifluorophosphate, O-ethyl-N,N,N′,N′-tetramethylisouronium tris(pentafluoroethyl)trifluorophosphate, S-ethyl-N,N,N′,N′-tetramethylisouronium trifluoromethanesulfonate, S-ethyl-N,N,N′,N′-tetramethylisothiouronium trifluoromethanesulfonate, among others.

The ionic liquids may also be categorized by the types of functional groups lacking from the cation. For example, the ionic liquid may lack an imidazolium cation. In another example, the ionic liquid may lack a nitrogen-containing heterocyclic cation.

In more additional examples, the ionic liquid may include a quaternary ammonium where the positively-charged central nitrogen is bonded to four substituent groups. In some examples, one or more of the substituent groups may be an organic group, such as an alkyl group. One sub-set of these examples includes quaternary ammonium salts having the formula:

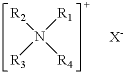

wherein R₁, R₂, R₃, and R₄ are independently halogen-substituted alkyl groups, and X is a halogen.

The halogen-substituted alkyl groups may include per-fluorinated alkyl groups were all the hydrogen atoms are substituted with fluorine atoms. For example, the halogen-substituted alkyl group may include CₓF₂ₓ₊₁ groups were x=1 to 20. The for moieties R₁₋₄ bonded to the central nitrogen may be the same or different. For example, two, three, or all four of the moieties may be the same, or all four moieties may be different. In a specific set of examples, three of the moieties are the same, while the fourth moiety represents a different per-fluorinated alkyl group. More specifically, the quaternary ammonium salt may have the formula:

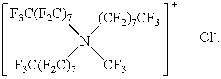

### The Solid-Phase Material Component

In addition to the ionic liquid, the present mixtures may also include a solid-phase precursor material. The solid-phase precursor materials may include metals, metal alloys, metal salts, semiconductors, semiconductor alloys, and salts of semiconductor compounds, among other compounds. More specific examples of groups of solid-phase precursor materials include hafnium compounds, indium compounds, ruthenium compounds, silicon compounds, selenium compounds, germanium compounds, gallium compounds, aluminum compounds, niobium compounds, tantalum compounds, strontium compounds, barium compounds, scandium compounds, yttrium compounds, lanthanum compounds, titanium compounds, zirconium compounds, tungsten compounds, copper compounds, zinc compounds, cadmium compounds, and mixtures of these compounds, among other compounds.

Solid-phase precursor materials that include hafnium compounds may include one or more of hafnium chloride (HfCl₄), hafnium iodide (HfI₄), hafnium ethyl methyl amide, tetrakis(diethylamino) hafnium (TDEAH), tetrakis(dimethylamino) hafnium (TDMAH), tetrakis(tert-butoxy) hafnium, tetrakis(diethylamino) hafnium, tetrakis(dimethylamino) hafnium, tetrakis(ethylmethylamino) hafnium, tetrakis(1-methoxy-2-methyl-2-propoxy) hafnium, bis(tert-butoxy)bis(1-methoxy-2-methyl-2-propoxy) hafnium, bis(methyl-n5-cyclopentadienyl)dimethylhafnium, and bis(methyl-n5-cyclopentadienyl)methoxymethylhafnium, among other hafnium-containing compounds. Ruthenium compounds may include one or more of ruthenium carbonyl, bis(2,4-dimethylpentadienyl) ruthenium, and bis(isopropyl-n5-cyclopentadienyl) ruthenium, among other ruthenium-containing compounds.

Solid-phase precursor materials that include silicon compounds may include one or more of silane, trisilane, dichlorosilane, trichlorosilane, tetraethylorthosilicate (TEOS), silicon tetrachloride, hexachlorodisilane, tris(dimethylamino) silane, tetrakis(dimethylamino) silane, tetrakis(ethylmethylaminio) silane, and N,N,N′,N′-tetraethyl silanediamine, among other silicon-containing compounds. Selenium compounds may include one or more of dimethylselenide and ditert-butylselenide, among other selenium-containing compounds. Germanium compounds may include one or more of tetraethoxygermanium, germane (10% in H₂), germanium tetrarchloride, tetramethoxygermanium, and tetrakis(dimethylamino)germanium, among other germanium containing compounds. Gallium compounds may include one or more of alkylgallium compounds such as trimethylgallium, and triethylgallium, among other gallium-containing compounds.

Solid-phase precursor materials that include aluminum compounds may include one or more of trimethylaluminum, dimethylaluminum hydride, and diethylaluminum ethoxide, among other aluminum-containing compounds. Niobium compounds may include one or more of pentakis(ethoxy) niobium, and pentakis(butoxy) niobium, among other niobium compounds. Tantalum compounds may include one or more of pentakis(dimethylamino) tantalum, pentakis(ethoxy) tantalum, pentakis(butoxy) tantalum, tetraethoxy(dimethylaminoethoxy) tantalum, tris(diethylamino)(tert-butylimido) tantalum, and tantalum pentachloride, among other tantalum-containing compounds. Strontium compounds may include one or more of bis(2,2,6,6-tetramethylheptane-3,5-dionato) strontium, and bis(pentakis(ethoxy)dimethylaminoethoxy)tantalum) strontium, among other strontium-containing compounds. Barium compounds may include bis(2,2,6,6-tetramethylheptane-3,5-dionato) barium, among other barium-containing compounds. Scandium compounds may include tris(2,2,6,6-tetramethylheptane-3,5-dionato) scandium, among other scandium-containing compounds.

Solid-phase precursor materials that include yttrium compounds may include one or more of tris(2,2,6,6-tetramethylheptane-3,5-dionato) yttrium, and tris(1-methoxy-2-methyl-2-propoxy) yttrium, among other yttrium-containing compounds. Lanthanum compounds may include tris(2,2,6,6-tetramethylheptane-3,5-dionato) lanthanum and tris(1-methoxy-2-methyl-2-propoxy) lanthanum, among other lanthanum-containing compounds. Titanium compounds may include titanium tetrachloride, tetrakis(diethylamino) titanium, tetrakis(dimethylamino) titanium, bis(isopropoxy) bis(2,2,6,6-tetramethylheptane-3,5-dionato) titanium, tetrakis(tert-butoxy) titanium, tetrakis(1-methoxy-2-methyl-2-propoxy) titanium, and bis(isopropoxy)bis(1-methoxy-2-methyl-2-propoxy) titanium, among other titanium-containing compounds. Zirconium compounds may include tetrakis(dimethylamino) zirconium, tetrakis(2,2,6,6-tetramethylheptane-3,5-dionato) zirconium, tetrakis(tert-butoxy) zirconium, tris(isopropoxy)mono(2,2,6,6-tetramethylheptane-3,5-dionato) zirconium, tetrakis(ethylmethylamino) zirconium, tetrakis(diethylamino) zirconium, bis(tert-butoxy)bis(1-methoxy-2-methyl-2-propoxy) zirconium, and bis(methyl-n5-cyclopentadienyl)methoxymethylzirconium, among other zirconium-containing compounds.

Solid-phase precursor materials that include tungsten compounds may include one or more of tungsten hexafluoride, and tungsten hexacarbonyl, among other tungsten-containing compounds. Copper compounds may include bis(2,2,6,6-tetramethylheptane-3,5-dionato) copper, among other copper compounds. Zinc compounds may include diethyl zinc, dimethyl zinc, and dimethyzinc triethylamine, among other zinc-containing compounds. Cadmium compounds may include dimethylcadmium, among other cadmium-containing compounds.

### Exemplary Precursor Supply Methods

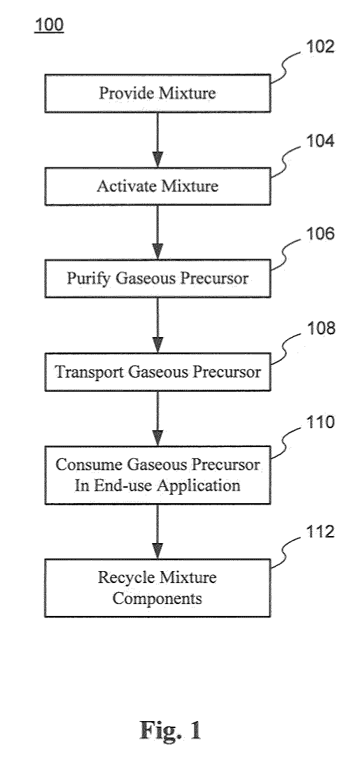

FIG. 1 shows selected steps in methods 100 of supplying a gaseous precursor to an application according to embodiments of the invention. The methods 100 may include the step of providing a mixture of a ionic liquid and a solid-phase precursor material 102. The solid-phase precursor material is the source of the gaseous precursor used in the application, while the ionic liquid provides a solution medium for the efficient storage (and often the stabilization) of the solid-phase precursor material.

The mixture of ionic liquid and solid-phase precursor material may be activated 104 in a number of different ways to produce the gaseous precursor. For example, the mixture may be heated to a temperature that causes a portion of the gaseous precursor to be released from the mixture. In some instances, at least a portion of the gaseous precursor may already be dissolved in the ionic liquid and the heating causes its release from the ionic liquid. In other instances, heating the mixture causes chemical or physical changes to the solid-phase ionic precursor that forms the gas precursor. In still other instances, heating the mixture causes chemical or physical changes to an intermediate compound formed from the solid-state precursor, and the temperature-activated intermediate compound forms the precursor gas. In some instances, combinations of two or more of these mechanisms may be involved in the release of the precursor gas from the thermally-activated mixture.

In additional examples, the mixture may be activated by applying a pressure gradient that causes a portion of the gaseous precursor to be released. The magnitude of the pressure change should be sufficiently strong to force the release of the precursor gas from the mixture. Some example pressure ranges may include atmospheric pressure to about 4000 psig; and about 10⁻⁷ torr to about 600 Torr at 25° C., among other ranges. The pressure gradient may be established at the interface between the bulk mixture and the volume above the mixture. For example, the pressure gradient may be established by pressurizing or evacuating the headspace of the container holding the mixture.

In another example, the mixture may be activated by mechanical or fluid agitation, including shaking the mixture, stirring the mixture, and spraging (e.g., bubbling) a gas through the mixture. For example, in spraging, a secondary gas may be introduced into the vessel in order to force the precursor gas from the mixture. The spraging gas may be introduced to the ionic liquid in a manner wherein the gas bubbles through the ionic liquid and displaces the precursor gas from the mixture. The secondary gas may also act as a carrier gas to transport the precursor gas to a downstream component of a precursor gas delivery system, such as a purifier, a temporary storage container, the end-use application, etc. The spraging gas may be a gas that has relatively low solubility in the ionic liquid and low reactivity with the precursor gas. The spraging gas may also be selected for its efficient release of precursor gas relative to the amount of spraging gas passed through the mixture. Examples of spraging gases may include molecular nitrogen (N₂), and noble gases such as helium, neon, argon, krypton, and xenon, among other types of gases.

In some embodiments of the methods 100, the precursor gas released by activating the mixture may optionally be purified 106 before being consumed in the end-use application. As noted above, the ionic liquid itself may act as a purifier by dissolving and retaining impurities from the solid-phase precursor to a greater extent than the precursor gas. The precursor gas is released with a reduced concentration of the impurities. Further purification may also be done on the precursor gases released from the mixture. This may include removing any vaporized ionic liquid that was released with the precursor gas. It may also include removing one or more impurities (e.g., moisture) remaining in the precursor gas.

Various purifying materials may be used to purify the released precursor gas, and may include, but are not limited to, alumina, amorphous silica-alumina, silica (SiO₂), aluminosilicate molecular sieves, titania (TiO₂), zirconia (ZrO₂), and carbon. The purification materials may be commercially available in a variety of shapes of different sizes, including, but not limited to, beads, sheets, extrudates, powders, tablets, etc. The surface of the purification materials can be coated with a thin layer of a particular form of a metal (e.g., a metal oxide or a metal salt) using methods known to those skilled in the art, including, but not limited to, incipient wetness impregnation techniques, ion exchange methods, vapor deposition, spraying of reagent solutions, co-precipitation, physical mixing, etc. The metal can consist of alkali, alkaline earth or transition metals. Commercially available purification materials includes a substrate coated with a thin layer of metal oxide (known as NHX-Plus™) for removing H₂O, CO₂ and O₂, H₂S and hydride impurities, such as silane, germane and siloxanes; ultra-low emission (ULE) carbon materials (known as HCX™) designed to remove trace hydrocarbons from inert gases and hydrogen; macroreticulate polymer scavengers (known as OMA™ and OMX-Plus™) for removing oxygenated species (H₂O, O₂, CO, CO₂, NOₓ, SOₓ, etc.) and non-methane hydrocarbons; and inorganic silicate materials (known as MTX™) for removing moisture and metals. All of these are available from Matheson Tri-Gas™, Newark, Calif. Further information on these purifying materials and other purification materials is disclosed in U.S. Pat. Nos. 4,603,148; 4,604,270; 4,659,552; 4,696,953; 4,716,181; 4,867,960; 6,110,258; 6,395,070; 6,461,411; 6,425,946; 6,547,861; and 6,733,734, the contents of which are hereby incorporated by reference.

The released (and optionally purified) precursor gas may be transported 108 from the mixture to the end-use application. Embodiments include in-situ generation of the precursor gas where the released gas generated on-site and is immediately available for use by the end-use application. Embodiments also include off-site generation of the released gas, where the gas is first transported to a storage vessel that is subsequently transported to the facility of the end-use application. The transportation of the released gas may involve the use of a carrier gas that absorbs and carries the precursor gas to the storage vessel, end-use application, etc.

Eventually, the precursor gas is used in the end-use application 110. For example, the end-use application may be a semiconductor fabrication application that consumes the precursor gas in a process to deposit a layer on a semiconductor substrate. Alternatively (or in addition), the precursor gas may also be used to clean or etch the semiconductor substrate.

In an optional step, the ionic liquid and/or solid-phase precursor material in a spent mixture may be recycled 112 by separating the ionic fluid and/or solid-phase precursor from impurities remaining in the mixture. The ionic liquid may be recycled by conventional methods of purifying and recycling liquid solvents. For example, recycled ionic liquid may be produced by filtering solid particulates from the liquid-phase components. In additional examples, the ionic liquid may be distilled from the mixture, or alternatively, the impurities may be evaporated to leave behind the recycled ionic liquid. Recycled ionic liquid may also be produced by passing the mixture through one or more purifier materials that capture impurities such as moisture, oxygen, etc. Similarly, conventional purification methods for dissolved or solid-phase materials may be used to recycle the solid-phase precursor remaining in the mixture. Also, combinations of purification methods may be used to produce the recycled ionic liquid or solid-phase precursor.

### Exemplary Precursor Delivery Systems

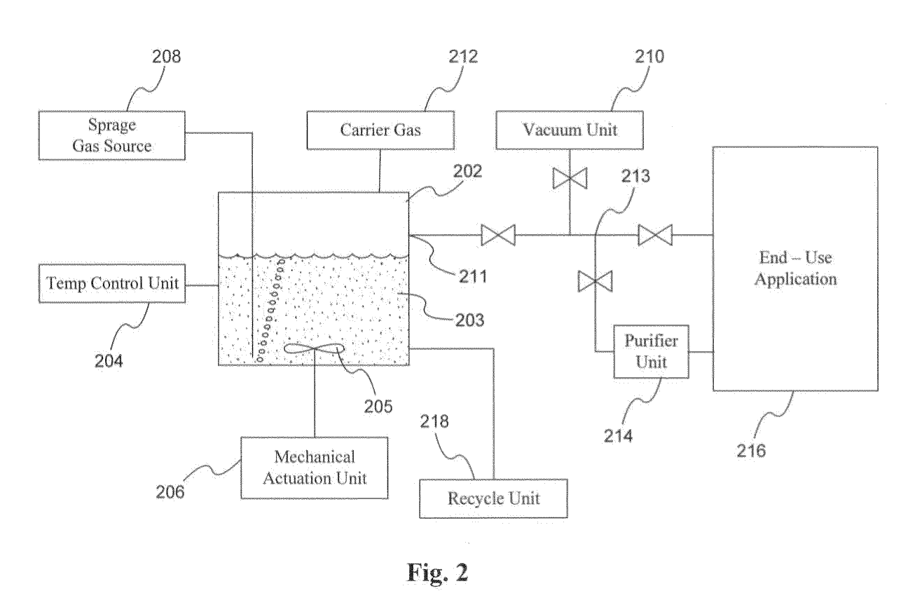

FIG. 2 shows a simplified schematic of a precursor delivery system 200 according to embodiments of the invention. The system 200 includes a storage unit 202 to hold the mixture that includes the ionic liquid and the solid-phase precursor starting material 203. The mixture may be prepared outside of the storage unit 202 and added as the complete mixture to the unit. Alternatively, components of the mixture (e.g., the ionic liquid, the solid-phase precursor) may be added separately to the storage unit 202 and the mixture formed in-situ in the unit. The storage unit 202 may be designed to store fluids at high pressure (e.g., about 2000 psi to about 5000 psi, or more) and may include a inner surface or liner exposed to the mixture which is made of a material with very low or no reactivity with the mixture. Examples of materials used in storage unit 202 may include carbon steel, stainless steel, nickel, and aluminum, among other materials. Examples of materials used in liners for storage unit 202 may include inorganic coatings, such as silicon and carbon, metallic coatings such as nickel, and organic coatings such as paralyene and polytetrafluoroethylene, among other liner materials. The storage unit 202 may be a permanent fixture in system 200, or may be reversibly coupled to the rest of the system to permit the exchange of old and new storage units between or during gas delivery operations.

The system 200 shows a number of components for activating the mixture to release the gaseous precursor. These include the temperature control unit 204 that is thermally coupled to the storage unit 202 and operable to heat or cool the mixture 203 stored in the unit. The temperature control unit 204 may be operable to adjust the temperature of the mixture 203 from a range of about −50° C. to about 600° C. (e.g., about −50° C. to about 400° C.; about 30° C. to about 350° C.; etc.).

The mixture 203 may also be mechanically agitated by mechanical stir unit 206. In the embodiment shown, stir unit 206 includes a propeller 205 inside the storage unit 202 that is mechanically actuated by an external motor. Alternative embodiments may include stir magnets (not shown) that are mechanically actuated by a magnetic stir motor positioned outside the storage unit 202. Still other alternative embodiments may include a vibration and/or sonication unit (not shown) to mechanically agitate the mixture 203.

The mixture 203 may be sparged with a source of spraging gas 208 that is coupled to a dip tube 209 for bubbling the spraging gas through the mixture 203. The spraging gas may displace and carry precursor gas from the mixture 203 to the headspace above the bulk mixture in the storage unit 202. From there, the combination of spraging gas and precursor gas may exit the storage unit 202 through the outlet 211 that is part of the gas delivery unit 213.

A vacuum 210 is also coupled to the gas delivery unit 213 an may be used to evacuate the headspace above the mixture 203 in storage unit 202. When used for this purpose, the vacuum 210 may participate in a pressure-mediated activation of the mixture to release the precursor gas. The vacuum 210 may also be used to evacuate conduits in the gas delivery unit 213 to remove impurities in these conduits before or after they transport the precursor gas from the storage unit 202.

A source for a carrier gas 212 is shown coupled directly to the headspace region of the storage unit 202. The carrier gas source 212 may supply gas to the storage unit in order to pressurize the unit as part of a pressure-mediated activation of the mixture to release the precursor gas. In addition, the carrier gas source 212 may be used to dilute and transport the precursor gas from the headspace and through the gas delivery unit 213.

Variations to the system 200 may include fewer than all the components shown to activate the mixture 203 to release the precursor gas. Additional embodiments may include a single component to activate the mixture 203, or a combination of two or more of these components.

The embodiment of the gas delivery unit 213 shown in FIG. 2 is configured with a branched manifold that is operable to transport the gas precursor either directly to the end use application 216, or to a purifier unit 214 that is also coupled to the end-use application. The purifier unit 214 may include equipment for a variety of purification techniques that remove impurities from the precursor gas that is eventually consumed by the end-use application 216. The end-use application may include a manufacturing application, such as a semiconductor fabrication application, a material coating application, etc.

The system 200 also includes a recycling unit 218 coupled to the storage unit 202 to recycle the ionic liquid and/or solid-phase precursor material. In some embodiments, the recycling unit 218 may be constructed to purify and replenish the mixture during gas delivery operations. This may allow the uninterrupted supply of the precursor gas to the end-use application 216. Additional embodiments may have a spent mixture 203 drained from the storage unit 202 into the recycling unit 218 where the ionic liquid and/or remaining solid-phase precursor material are separated and recycled. The end-product of the recycling unit 218 may include a purified component of the mixture 203 (e.g., purified ionic liquid and/or purified solid-phase precursor material) or a recycled mixture that can refill the storage unit 202 for additional precursor gas supply, among other end-products.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the solid material” includes reference to one or more solid materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. An ionic fluid mixture comprising:
an ionic liquid; and
a solid phase material, wherein the solid phase material is converted into a gas phase material at a temperature that is lower than a conversion of the ionic liquid into a gas phase ionic material.

2. The ionic fluid mixture of claim 1, wherein the ionic liquid is selected from the group consisting of a mono-substituted imidazolium salt, a di-substituted imidazolium salt, a tri-substituted imidazolium salt, a pyridinium salt, a phosphonium salt, an ammonium salt, a tetralkylammonium salt, a guanidinium salt, a isouronium salt, and combinations of the salts.

3. The ionic fluid mixture of claim 1, wherein the ionic liquid comprises a quaternary ammonium salt.

4. The ionic fluid mixture of claim 3, wherein the quaternary ammonium salt comprises one or more halogen groups.

5. The ionic fluid mixture of claim 3, wherein the quaternary ammonium salt has the formula: 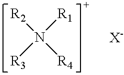
wherein R₁, R₂, R₃, and R₄ are independently a halogen-substituted alkyl group, and
X is a halogen.

6. The ionic fluid mixture of claim 5, wherein the quaternary ammonium salt has the formula:

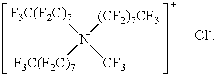

7. The ionic fluid mixture of claim 1, wherein the solid phase material is selected from the group consisting of a hafnium compound, a indium compound, a ruthenium compound, a silicon compound, a selenium compound, a germanium compound, a gallium compound, an aluminum compound, a niobium compound, a tantalum compound, a strontium compound, a barium compound, a scandium compound, a yttrium compound, a lanthanum compound, a titanium compound, a zirconium compound, a tungsten compound, a copper compound, a zinc compound, and a cadmium compound.

8. The ionic fluid mixture of claim 1, wherein the solid phase material comprises a hafnium halide salt.

9. The ionic fluid mixture of claim 8, wherein the solid phase material comprises hafnium chloride (HfCl₄).

10. A system to deliver a gaseous precursor from a solid-phase starting material, the system comprising:
a storage unit to hold a mixture comprising an ionic liquid and the solid-phase starting material;
a heating unit thermally coupled to the storage unit to increase a temperature of the mixture in the storage unit;
a gas delivery unit fluidly coupled to the storage unit and adapted to transport the gaseous precursor that is formed by heating the solid phase starting material in the mixture, wherein the gas delivery unit transports the gaseous precursor to an application that is coupled to the system.

11. The system of claim 10, wherein the storage unit comprises a vessel to hold the mixture, wherein the vessel comprises a fluid inlet and a fluid outlet, wherein the fluid inlet is coupled to a carrier gas supply that is introduced to the mixture, and the fluid outlet is coupled to the gas delivery unit.

12. The system of claim 11, wherein the fluid outlet is further coupled to a vacuum unit.

13. The system of claim 11, wherein the heating unit comprises a heating element in thermal contact with at least a portion of the vessel holding the mixture.

14. The system of claim 10, wherein the application comprises a semiconductor fabrication system.

15. A method of supplying a gaseous precursor to an application, the method comprising:
providing a mixture of an ionic liquid and a solid-phase starting material;
heating the mixture to a temperature that vaporizes at least a portion of the solid-phase starting material into the gaseous precursor, wherein the temperature is lower than a boiling point of the ionic liquid; and
transporting the gaseous precursor from the mixture to the application that utilizes the gaseous precursor.

16. The method of claim 15, wherein the ionic liquid comprises a quaternary ammonium salt, and the solid-phase starting material comprises a metal salt.

17. The method of claim 16, wherein the quaternary ammonium salt has the formula: 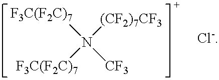
and the metal salt is hafnium chloride (HfCl₄).

18. The method of claim 15, wherein the mixture is heated up to about 400° C.

19. The method of claim 15, wherein at least a portion of the ionic liquid is recovered from prior mixtures of the ionic liquid and the solid-phase starting material.

20. The method of claim 16, wherein the application is a semiconductor fabrication application.
